(19) United States
(12) Patent Application Publication
(10) Pub. No.: US 2003/0234534 A1
(43) Pub. Date: Dec. 25, 2003

(54) Multi-label mailing form for non-impact printer

(76) Inventor: Warren M. Fabel, Boca Raton, FL (US)

Correspondence Address: Ted W. Whitlock, Registered Patent Attorney P.A., 5323 SW 38th Avenue, Ft. Lauderdale, FL, 33312, US

(21) Appl. No.: 10/378,163

(22) Filed: Feb. 28, 2003

Related U.S. Application Data
(60) Provisional application No. 60/361,379, filed on Mar. 1, 2002.

(51) Int. Cl. B42D 15/00

(52) U.S. Cl. 283/106

(57) ABSTRACT

A form assembly formed by front and back plies for creating a postcard having printing on both faces from a single pass through a non-impact printing device.

### BACKGROUND OF THE INVENTION

U.S. Pat. Nos. 5,836,622 and 6,257,624, which are hereby incorporated by reference, teach the ability to print a duplex form with a single pass through a simplex non-impact printer. This allows the user to produce a duplex Postcard without the need for pre-printing. However, these previous patents do not provide for printing of three post cards from a single form.

Other forms that are commercially available provide three postcards on a standard paper size and are printable on the installed base of non-impact printers for purposes of economy and throughput. These products are known in the industry as “3-up” forms. However, these commercially available 3-up products require pre-printing or processing on a duplex printer.

What is needed is a multiple transaction Postal form, utilizing the least amount of materials, which will process on the installed base of non-impact printers, and which does not require preprinting in order to provide variable printed information on the front and back faces of the form.

### SUMMARY OF THE INVENTION

The subject invention concerns a more efficient mailing form comprising a post card or other printable document wherein address or other variable information can be printed on both front and back faces of the document by a single pass through a simplex printer. The subject form assembly comprises folding flap, printable on the front face of the assembly and is provided for printing of variable information such as the return address. The folding flap is preferably approximately ⅓ the total height of the post card, therefore saving area on the form assembly and allowing up to three post cards of size and thickness acceptable for United States Postal Service (USPS) specifications to be provided on a single legal size (8½×14″) sheet; up to two post cards of USPS-acceptable size and thickness on a single A4 (8½×12¼″) sheet, or one post cards of USPS-acceptable size and thickness on a single 8½×5½″ sheet, which will advantageously pass through an envelope feeder of a conventional home or home-office non-impact printer.

### BRIEF DESCRIPTION OF THE DRAWINGS

FIG. 1 is a plan view of the front (outer) face of the top ply of a 3-up embodiment of a form assembly according to one embodiment of the invention.

FIG. 2 is a plan view of the back (inner) face of the top ply of a 3-up embodiment of a form assembly according to one embodiment of the invention.

FIG. 3 is a plan view of the inner face of the back ply of a 3-up embodiment of a form assembly according to one embodiment of the invention. FIG. 4 is a plan view of the outer face of the back ply of a 3-up embodiment of a form assembly according to one embodiment of the invention.

### DETAILED DESCRIPTION OF THE INVENTION

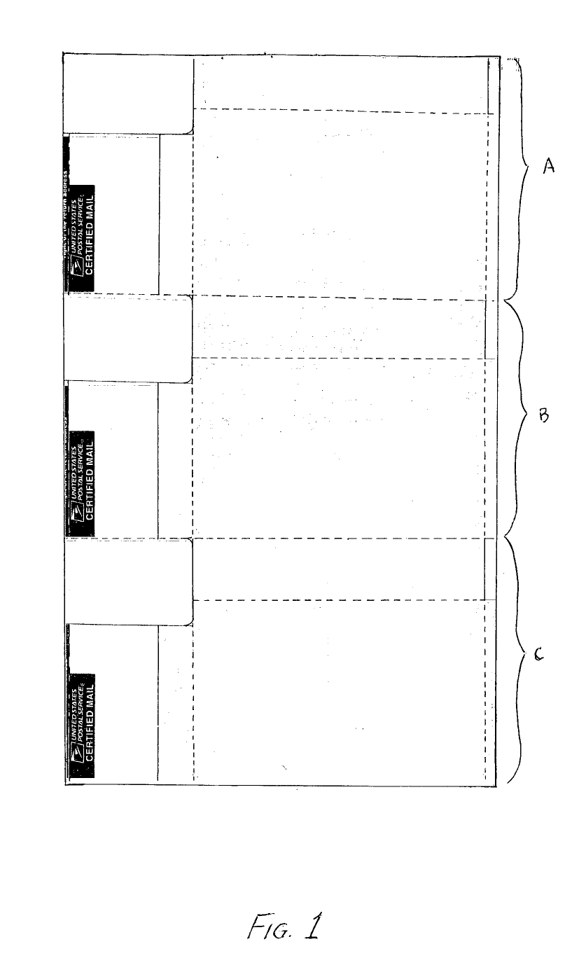

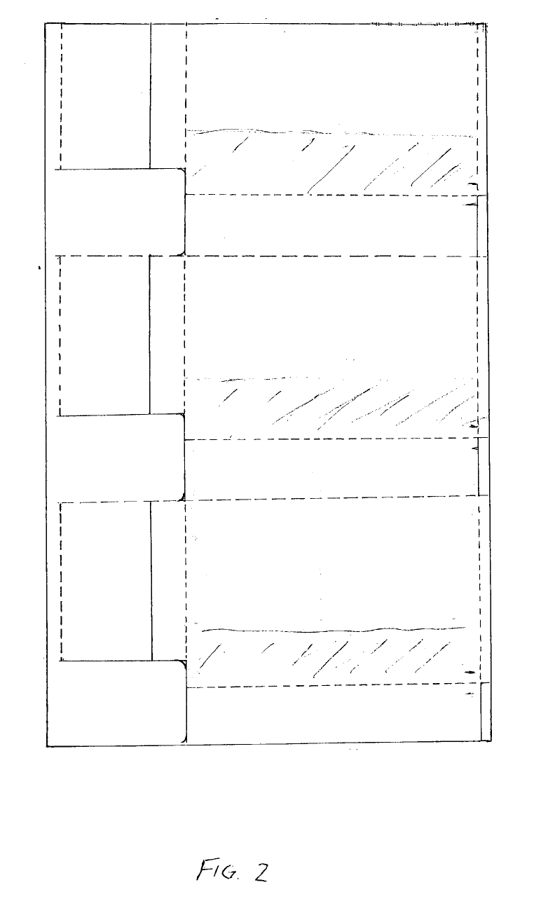

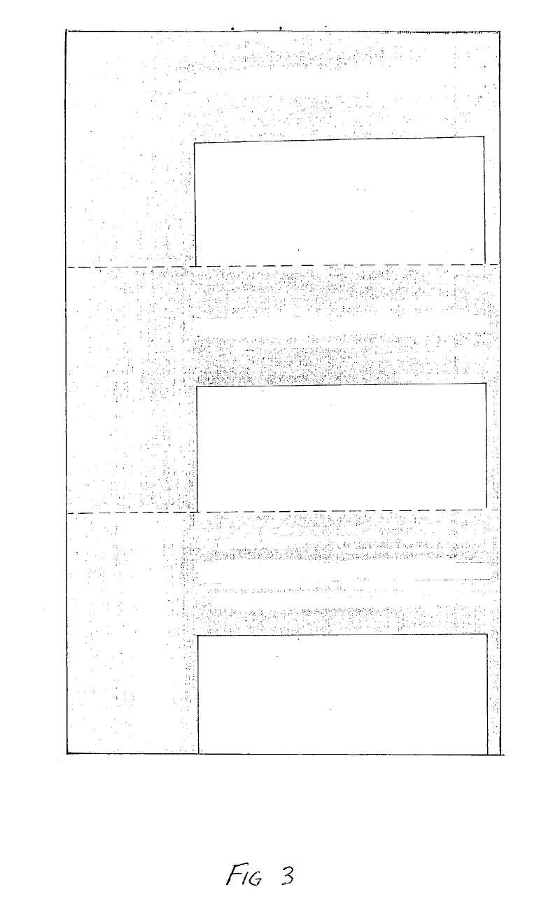

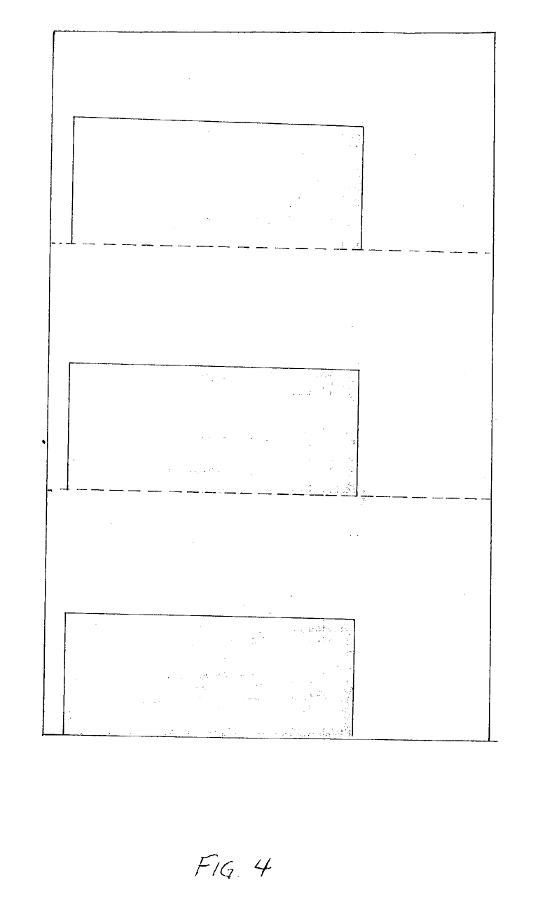

The subject invention comprises a two-ply form. The first or front ply has a front face (shown in FIG. 1) die-cut or perforated for providing a plurality of postcard forms and removable labels, and a back face having adhesive material patternly disposed thereon over substantially the entire surface of the inner face, except in the shaded areas as shown in FIG. 2 which are adhesive-free. The second or backing ply has an first inner face which meets the back face of the front ply, and has adhesive release material diposed thereon substantially as shown as shaded area in FIG. 3. The back face of the backing ply, shown in FIG. 4 can have patterned coloring or shading as desired. The backing strip on the back ply is preferably about twice the height of the fold-over flap so that when the flap is folded, the postcard is uniform in thickness with no possibility of an address label being sheared off in postal processing. The upper half of the removable backing is initially attached with glue stripes. This “striping” disposition of the adhesive or glue allows maximum contact of the folded flap to non-silicon areas to produce a relatively permanent bond.

Additionally, processing steps are reduced to a minimum. After the multiple form is separated into individual transactions at the tear lines, the form is curled to pop the post card from the backing, and then folded and affixed to the back, outer face of the card to provide an address area on that face.

Generally, the invention has been described in its preferred form or embodiment with some degree of particularity, it is to be understood that this description has been given only by way of example and that numerous changes in the details of construction, fabrication and use, including the combination and arrangement of parts, may be made without departing from the spirit and scope of the invention.

1. A unitary mailing form having discrete sections for printing mailing indicia or mailing information thereon by a non-impact printer, said form comprising a front sheet having die-cuts or perforations defining said discrete sections on which mailing information or mailing indicia are printed on a front face, a back face of the front sheet having adhesive material or adhesive release material patternly disposed thereon, a back sheet having die-cuts or perforations substantially conforming to the die-cuts or perforations of the front sheet, said back sheet having a front face on which adhesive release material is patternly disposed thereon, and a back face on which instructional information can be printed.

2. The mailing form of claim 1, wherein each discrete section is connected to at least one other discreet section.

3. The mailing form of claim 1, wherein mailing indicia and addressee information are printed on a single discrete section.

4. The mailing form of claim 1 wherein the mailing form is adapted for providing a post card.

5. The mailing form of claim 1 wherein the mailing form is adapted for providing three post cards on a single legal size sheet.
